(19) United States
(12) Patent Application Publication
(10) Pub. No.: US 2008/0012688 A1
(43) Pub. Date: Jan. 17, 2008

(54) SECURE RFID BASED ULTRA-WIDEBAND TIME-HOPPED PULSE-POSITION MODULATION

(76) Inventors: Dong Sam Ha, Blacksburg, VA (US); Patrick Schaumont, Blacksburg, VA (US)

Correspondence Address: BLANK ROME LLP, 600 NEW HAMPSHIRE AVENUE, N.W., WASHINGTON, DC, 20037, US

(21) Appl. No.: 11/773,734

(22) Filed: Jul. 5, 2007

Related U.S. Application Data
(60) Provisional application No. 60/818,535, filed on Jul. 6, 2006.

(51) Int. Cl. H04Q 5/22

(52) U.S. Cl. 340/10.1; 340/572.1; 340/10.34; 375/138

(57) ABSTRACT

A radio-frequency-identification (RFID) system includes an RFID tag and an RFID reader, where the RFID reader is configured to communicate with the RFID tag using time-hopped pulse-position modulation and ultra-wideband modulation. The time-hopped pulse-position modulation includes sending from the RFID tag to the RFID reader a series of pulses in time slots selected by the RFID tag through a cryptographically secure pseudo-random generator.

### CROSS-REFERENCE TO RELATED APPLICATIONS

This application claims benefit of U.S. Provisional Patent Application No. 60/818,535, filed on Jul. 6, 2006. The full disclosure of this provisional application is hereby incorporated herein by reference.

### FIELD OF THE INVENTION

The present invention is directed to active and passive communication systems that allow for identification. The present invention is further directed to radio-frequency-identification (RFID) tag systems with improved security.

### DESCRIPTION OF RELATED ART

RFID systems have proven very useful in a myriad of settings, such as goods identification and tagging for toll collections. There is an increasing need for the next generation of RFIDs to have higher confidentiality, integrity, authentication, and availability. TABLE 1 shows a few examples of some existing and proposed RFID systems. The first RFID system, in row one, measures 0.4 mm by 0.4 mm in die size and contains a unique 128-bit identifier. It does not implement any security protection or communication collision detection. Rows two and three of TABLE 1 are two secure RFID systems which both implement proprietary cryptography with limited key-lengths. These proprietary ciphers are simplified and cryptographically weaker than standards such as the FIPS-197 Advanced Encryption Standard (AES). It has been estimated that the design budget for cryptographic hardware in a next-generation secure RFID system is only about 2,000 gates. As a reference, one of the smallest available implementations for the Advanced Encryption Standard still requires over 3,500 gates. See, for example, M. Feldhofer et al., “Strong Authentication for RFID Systems using the AES Algorithm,” Proc. of the 2004 Cryptography Hardware and Embedded Systems Conference, LNCS 3156. In order to reduce the implementation complexity and hardware requirements, systems have been proposed that use weak cryptography(such as short keys and/or simple ciphers). The use of weak cryptography, however, is not an adequate solution to the secure RFID problem. Such systems are susceptible to reverse engineering and brute-force attacks, as discussed, for example, in S. Bono et al., “Security Analysis of a cryptographically-enabled RFID Device,” Proc. of the 14^{th} USENIX Security Symposium (USENIX05), August 2005.

TABLE 1

| | | | |
|---|---|---|---|
| Storage | Security | Scan Range | Power |

| | | | | |
|---|---|---|---|---|
| 128 | bits | None | 25 cm | 3 μW |
| 88 | bits | 40-bit Key | 60 cm | n.a. |
| 320 | bits | 64-bit Key | 50 cm | 27 μW |
| 128-512 | bits | [2000 gates] | 300 cm | 10 μW |

Having a power-limited environment for cryptographic operations has a second important consequence; the operations have to run at low speed. This is because the power consumption of a digital circuit is proportional to its clock frequency. Typically, the clock of digital RFID hardware runs slower than 100 KHz. According to the ISO/EIC 18000 standard, an RFID must reply to its reader within 320 μs. At a digital clock of 100 KHz, this leaves only 32 cycles for encryption, in the most optimal case. The implementation of standard cryptographic operations in the power- and area-constrained RFID environment requires a much larger cycle budget. For example, Feldhofer et al., presented an implementation of AES for RFIDs that needs 992 clock cycles for a 128-bit encryption. In J. Wolkerstorfer, “Scaling ECC Hardware to a minimum,” 2005 Workshop on Cryptographic Advances in Secure Hardware (CRASH), September 2005, it was presented that a public-key processor for RFIDs based on elliptic-curve cryptography needs 426,000 clock cycles for a scalar elliptic-curve multiplication on a 192-bit field. Consequently, digital cryptography in RFID causes a severe latency-problem that fails to meet present-day standards.

Recent work in so-called ‘light-weight’ protocols tries to improve this by alleviating the requirements of encryption or even eliminating them altogether. The HB+ protocol, for example, uses a protocol modeled after human authentication. It uses repeated challenges directly derived from the shared key K. Unfortunately the HB+ protocol is not resistant against active attacks. See, for example, “An Active Attack Against HB+—A Provably Secure Lightweight Authentication Protocol, Cryptology ePrint Archive 2005, publication 237.

Besides HB+, several good proposals have been presented recently, all of which use a cryptographic primitive (hash function, cipher, message authentication, and so forth). The hash-lock scheme from S. Sarma et al., “RFID systems and security and privacy implications,” Proceedings of the 2002 Cryptographic Hardware and Embedded Systems Workshop (CHES02), pp. 454-469, Springer, 2002, uses the concept of a lock based on hash-functions. The YA-TRAP protocol from C. Tsudik, “YA-TRAP: Yet Another Trivial RFID Authentication Protocol,” Proceedings of the International Conference on Pervasive Computing and Communications, PerCom 2006, relies on time-stamping RFIDs and a hash function to prevent unauthorized tracking.

Given the above discussed applications, there does not seem to be an easy solution that will make cryptographic primitives in authentication protocols obsolete. Rather, what is needed is a significantly more efficient implementation of those secure protocols.

### SUMMARY OF THE INVENTION

It is thus an object of the present invention to provide an RFID tag with secure authentication that allows only legitimate users to access its content and offers a wide range of applications such as electronic car keys, electronic purses, and anti-counterfeiting. To achieve the above and other objects, the present invention is directed to a radio-frequency-identification system which includes an RFID tag and an RFID reader, where the RFID reader is configured to communicate with the RFID tag using time-hopped pulse-position modulation and ultra-wideband modulation.

Current secure implementations of RFID rely on cryptographic hardware. This results in complex hardware with high power dissipation. In addition, existing passive RFID systems rely on simple coding and modulation schemes using narrowband radio frequencies, which can be easily eavesdropped or jammed. The present invention is directed to systems that secure the physical communications between RFIDs and readers, rather than to secure the contents of RFIDs by encryption. The present invention uses time-hopped pulse-position modulation (TH-PPM) and ultra wideband (UWB) modulation, which makes eavesdropping extremely difficult. The method of the present invention simplifies the cryptographic requirements or even eliminates them altogether, while offering the same level of security as existing passive RFIDs.

Preferably, the time-hopped pulse-position modulation may include sending from the RFID tag to the RFID reader a series of pulses in time slots selected by the RFID tag through a pseudo-random generator. The RFID reader may also be configured to communicate with the RFID tag through a narrowband communication, where that narrowband communication may provide power and command signals to the RFID tag. The RFID tag may communicate with the RFID reader using pulses of approximately 60 μs in width and/or time slots of approximately 950 ps in width.

Additionally, the present invention is also directed to a radio-frequency-identification system having an RFID tag and an RFID reader, where the RFID reader is configured to communicate with the RFID tag using narrowband communication initially and subsequently through broadband communication. The broadband communication may include ultra-wideband modulation and time-hopped pulse-position modulation.

The present invention is also directed to a method of communicating within a radio-frequency-identification system having the steps of sending a narrowband signal from an RFID reader to an RFID tag and receiving data signals from the RFID tag to the RFID reader through broadband communication using time-hopped pulse-position modulation and ultra-wideband modulation. The method may also include sending a second narrowband signal from the RFID reader to at least one additional RFID tag and receiving data signals from the at least one additional RFID tag to the RFID reader through broadband communication using time-hopped pulse-position modulation and ultra-wideband modulation. The broadband communications between the RFID reader and the RFID tag and the at least one additional RFID tag may also be synchronized by the RFID reader.

### BRIEF DESCRIPTION OF THE DRAWINGS

A preferred embodiment of the present invention will be set forth in detail with reference to the drawings, in which:

FIG. 1 is an schematic diagram of time-hopped pulse-position modulation processes, with FIG. 1(a) illustrating the slots as a function of time, with FIG. 1(b) illustrating a bit value of zero and with FIG. 1(c) illustrating a bit value of one according to at least one embodiment of the present invention;

FIG. 2 illustrates the overall architecture of a UWB-RFID system, according to at least one embodiment of the present invention;

FIG. 3 illustrates the UWB frame format for secure RFID, with FIG. 3(a) illustrating the ID-level, with FIG. 3(b) illustrating the bit-level and with FIG. 3(c) illustrating the pulse-level, according to at least one embodiment of the present invention; and

FIG. 4 is a schematic showing communication between elements of the system with reader synchronization, according to at least one embodiment of the present invention.

### DETAILED DESCRIPTION OF THE PREFERRED EMBODIMENT

A preferred embodiment of the present invention will be set forth in detail with reference to the drawings, in which like reference numerals refer to like elements or operational steps throughout.

Since the Federal Communications Commission's (FCC's) allocation of a UWB spectrum in the range of 3.1 GHz to 10.6 GHz in 2002, UWB has gained phenomenal interest in academia and industry. Compared to traditional narrowband communication systems, UWB has several advantages including high data-rate, low average radiated power, and simple RF circuitry. Many of these potential advantages are a direct consequence of UWB's large instantaneous bandwidth. Shannon's theorem states that the channel capacity C is given as B log₂(1+SNR), where B is the bandwidth and SNR is the signal-to-noise ratio, as discussed in J. G. Proakis, Digital Communications, McGraw-Hill, 1995. As the bandwidth B is much larger (on the order of several GHz) for UWB than for a narrowband signal, the SNR can be much smaller for UWB to achieve the same data rate. Therefore, UWB is often able to recover data, even if the signal power is close to the noise level. In other words, the presence of UWB signals is harder to detect than narrowband signals.

The IEEE 802.15 WPAN task group has recognized the potential of UWB for low data rate applications, and is in the process of standardizing the physical layer. Numerous UWB radio architectures targeting low-power low data-rate UWB applications including RFIDs have been proposed. G. P. Hancke et al., “An RFID Distance Bounding Protocol,” Proceedings of SecureComm, pp. 67-73, 5-9 Sep. 2005, presented a paper on securing RFIDs using UWB, where the authors suggested that measuring the signal propagation delay between an RFID and the reader using UWB. If the delay exceeds a certain bound, the system signals a possible attack.

UWB signaling can be carrier-based or impulse-based, and impulse-based UWB is more suitable for the RFID due to its simple hardware. Impulse-based UWB is based on a train of narrow pulses (which are typically a few tens to hundreds picoseconds wide). Various modulation schemes such as on-off keying, pulse amplitude modulation, pulse position modulation (PPM), and binary phase shift keying are available for UWB. A binary PPM scheme has 2 distinctive time positions in a time slot, and one pulse carries 1 bit of information. In a preferred embodiment, PPM is adopted due to its low hardware complexity.

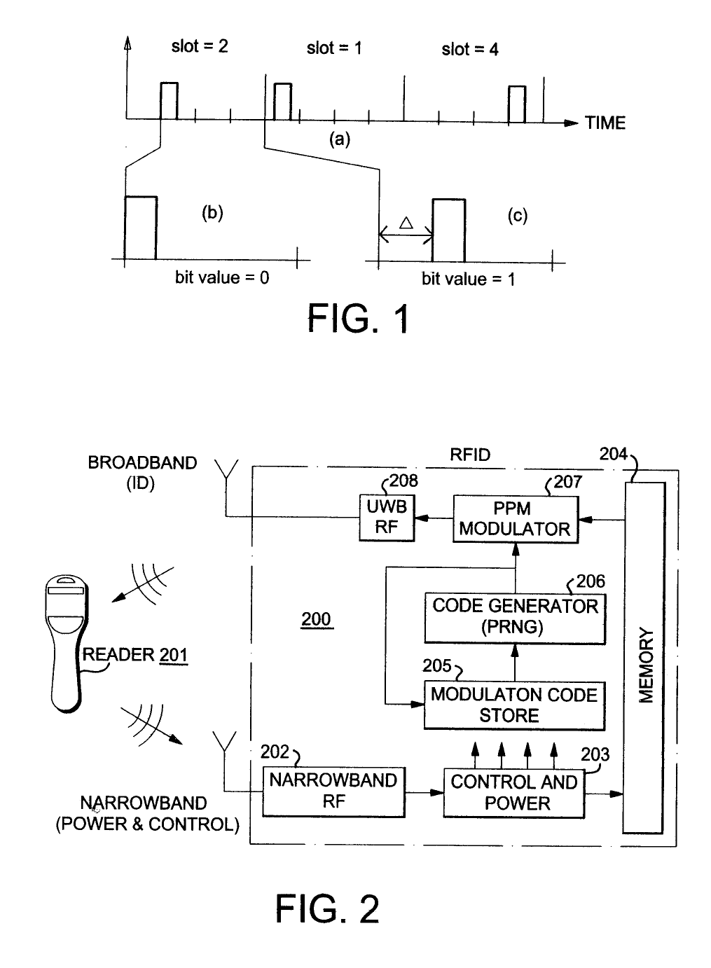

A k-bit time hopping PPM (TH-PPM) allocates 2 k time slots for each bit and hops time slots between pulses. FIG. 1(a) shows an example TH-PPM scheme with four time slots in each cycle. The first pulse occupies the second time slot, the second pulse the first slot, and the third pulse the fourth slot in the figure. Like any other PPM, the position of a pulse within a time slot carries the bit information for TH-PPM. For example, a pulse aligned to the start of a slot represents logic 0 (FIG. 1 (b)). A pulse delayed by Δ with respect to the start of a time slot carries logic 1 (FIG. 1(c)). So far, time-hopping has been used in communications for two purposes, multiple access and/or spreading of the spectrum. A multiple access scheme assigns orthogonal time hopping sequences to all users, so that the users can share the channel simultaneously. When a train of pulses are time-hopped, it spreads the spectrum to yield so-called spreading gain. The present application introduces a new application of time-hopping, which is to secure physical layer communications through time-hopping.

To demodulate extremely narrow UWB pulses, a receiver should correlate incoming pulse signals with a template signal. The time slot of an incoming pulse is known a priori for a conventional TH-PPM scheme. The receiver performs two correlations starting at two different time spots, one at t=0 as for the case in FIG. 1(b) expecting a logic value 0 for the incoming signal and the other at t=Δ as in FIG. 1(c) expecting logic 1. One of the two correlation operations will capture the received signal energy, while the other one will only correlate noise. If the time slots of pulses are assigned in a pseudo random manner, the eavesdropper should perform correlations for all possible time slots. If the total number of time slots is sufficiently large and each time slot is sufficient small, eavesdropping of TH-PPM communications is practically impossible.

FIG. 2 shows a block diagram of our proposed secure RFID system. Like existing RFID systems, the downlink from a reader 201 to an RFID 200 relies on narrowband communications 202. The downlink sends commands to an RFID and delivers power 203. Narrowband communication is adopted to maximize power transfer to the RFID. Note that the information over this link can be easily detected and decoded, but the information, i.e., commands, is trivial

According to the present invention, the uplink from an RFID to the reader adopts UWB communications and a TH-PPM scheme 208. This link transfers the unique and critical ID stored in the RFID's memory 204 to the reader, and requires protection. A pseudo-random generator (PRNG) 206 generates the modulation code, i.e., the time slot of a pulse. A PRNG generates pseudorandom numbers which results in a random sequence. In certain embodiments, after the completion of the read cycle, the RFID stores the last code (which is the status of the PRNG) in a non-volatile memory 205. It should be noted that such storage makes the system more difficult to hack, but is not essential to secure system operation. In those certain embodiments, when the RFID goes through another readout cycle, it generates a set of new pseudorandom modulation codes, one at a time, using the previous code stored in the memory. The newly generated codes select the time slots of the pulses to transfer the ID 207. The secrecy of the RFID transmission lies in the fact that it is hard to intercept the pulse-train if one does not know the time slots of the pulses. This is so because UWB pulses are very narrow (about 100 ps wide), and detection of UWB pulses require precise timing synchronization.

Examples of transmission for the secure RFID system of the present invention are provided below. The basic transmission frame format is discussed, followed by a security analysis. Next, the communication protocol is extended to enable simultaneous operation of multiple readers and multiple RFID.

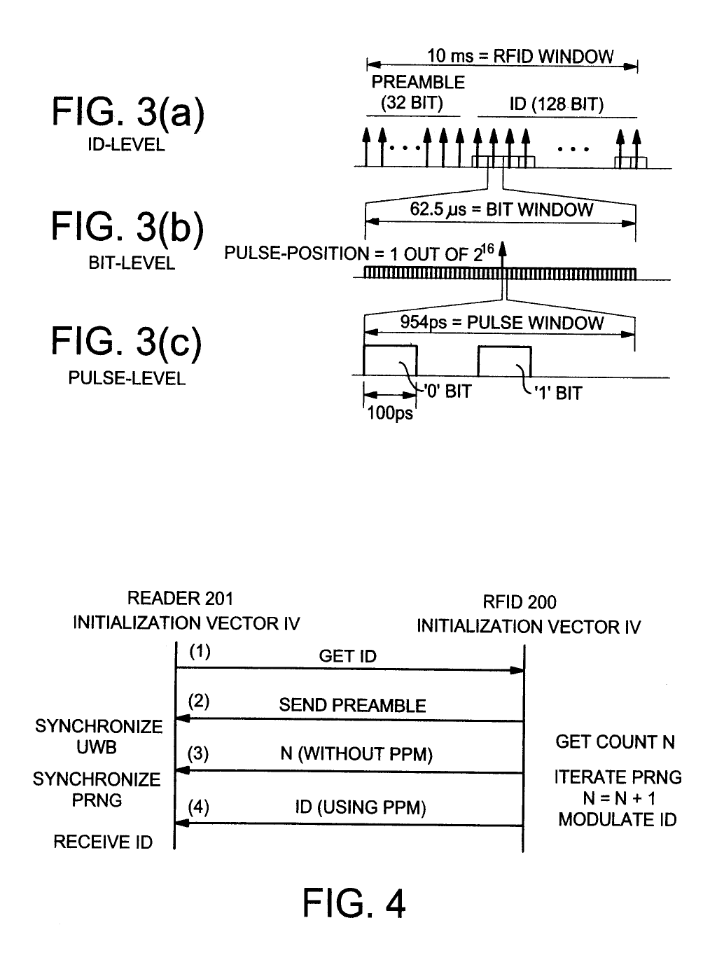

FIG. 3 illustrates a frame for the transmission of a single ID. The transmission needs to complete within 10 ms, similar to present-day non-secure RFIDs, in which a preamble occupies 2 ms and the ID 8 ms. The first 32 bits of the frame is a preamble, as shown in FIG. 3(a), which is required to synchronize the reader. These pulses occupy the same time slot (such as the first time slot) of each cycle. Next, a pulse train of 128 bits follows, each pulse position being modulated pseudo-randomly by a PRNG. The cycle time, i.e., time window of a pulse, in this example, is 62.5 μs. The system in FIG. 3 uses a 16-bit pulse-position code, resulting in 2¹⁶ (=65,536) time slots, as illustrated in FIG. 3(b), with each slot 954 ps long. This slot length is long enough for a pulse not to interfere with the pulse from the next time slot.

Initially, the reader sends a narrowband RF carrier to the passive tag, which allows the tag to power up. The power-up stage may require a few milliseconds. When the reader is ready to query the tag, it briefly interrupts the RF carrier. This small gap does not cause power-loss for the tag, but can be used to reset the system.

The tag clock, which is derived from the narrowband carrier signal, is synchronous to the carrier clock of the reader, but delayed by Δ seconds, where Δ is the sum of the round trip flight time of the radio signal between the reader and the tag and the processing time for a tag to detect the carrier and send the first pulse. The processing time is fixed and known a priori, so it does not affect the window size of the synchronization time search.

The attacks on an RFID fall into three categories: physical attacks on the RFID electronics themselves, passive attacks based on eavesdropping the RFID transmissions, and active attacks by disturbing or enhancing the RFID transmissions. In this application, the focus is on the latter two attacks, passive and active. It should be noted that the risk for physical attacks for systems according to the present invention is similar to that of existing RFIDs.

Passive Attacks: Using FIG. 3, the risk that an attacker is able to ‘pick up’ the transmissions of an UWB RFID is illustrated. Suppose that an attacker successfully synchronizes his/her reader (or a UWB receiver) using the preamble. A brute-force attack is to capture every signal within the remaining 8 ms transmission window of an RFID. To capture enough energy for each pulse with duration of 100 ps, it would be necessary to capture at least ten samples for a pulse. This requires about 168 megasamples (which is 20 samples for each time slot, for 65,536 slots per pulse and 128 pulses per read cycle)—this is a very expensive measurement in terms of complexity and instrumentation cost. More importantly, the ADC (analog-to-digital converter) used to sample these pulses should operate at the sampling rate of 100 gigasamples per second, which is not feasible for current technologies.

An alternative attack strategy would be to read a certain fixed time slot, for example, always to read the first slot of each cycle, and perform multiple RFID read operations until each pulse of 128 bits hits the time slot at least once. This would need, on average, 65,536/2 read operations for the above example protocol shown in FIG. 2. A straightforward countermeasure is to increase the number of time slots per cycle, but as this also increases the clock frequency of the PPM modulator and hence the power dissipation, it is not an optimal choice. Another countermeasure is as follows: deactivate the RFID after a certain number of read operations, defined by its expected lifetime. This scheme is still much simpler than cryptographic operations in hardware.

Active Attacks: An attacker may attempt to modify the UWB transmission between the RFID and the reader. This kind of attack requires disruption of the signal exactly at the position where an UWB pulse is located, and hence requires the knowledge on the modulation code. If the objective would be only to jam the signal, a transmitter should generate a distortion pulse at each possible pulse position. This requires a significant amount of transmission power in the GHz range, which is very expensive in hardware.

While it is not possible to claim that secure UWB will perfectly resist attacks, it can reasonably be assumed that such attacks are difficult to mount. In addition, the eavesdropping protection offered by UWB is much cheaper in hardware and is complementary to traditional cryptography used in RFIDs.

When multiple readers access the same UWB-RFID, they have to synchronize their internal PRNG to that of the RFID. The protocol shown in FIG. 4 can handle this problem. Both a reader 201 and an RFID 200 use the same initialization vector for the PRNG as a shared secret. When the reader requests to read the RFID, the RFID replies by sending a preamble followed by the number of times that it has already been read, the read count N. This number is transmitted using a fixed pulse-position code, and allows the reader to synchronize an internal PRNG to the same sequence as the RFID. Next, the RFID transmits the actual ID, this time using pulse-position modulation. While this protocol allows an attacker to know how many times an RFID has been read, it safeguards the actual ID.

A strong point of using UWB modulation is that multiple RFIDs can coexist and transmit simultaneously. Indeed, given appropriate reader hardware, multiple concurrent RFID transmissions can be detected since they can overlap at the physical layer without conflicts. It is expected that this property can lead to considerable simplification of the so-called tree-walking protocols required for narrowband RFIDs.

While a preferred embodiment has been set forth in detail above, those skilled in the art will readily appreciate that other embodiments can be realized within the scope of the invention. For example, numerical values are illustrative rather than limiting, as is the order in which steps are carried out. Therefore, the present invention should be construed as limited only by the appended claims.

What is claimed is:

1. A radio-frequency-identification (RFID) system comprising:
an RFID tag; and
an RFID reader, where the RFID reader is configured to communicate with the RFID tag using time-hopped pulse-position modulation and ultra-wideband modulation.

2. The RFID system, as recited in claim 1, wherein the time-hopped pulse-position modulation comprises sending from the RFID tag to the RFID reader a series of pulses in time slots selected by the RFID tag through a pseudo-random generator.

3. The RFID system, as recited in claim 1, wherein the RFID reader is further configured to communicate with the RFID tag through a narrowband communication.

4. The RFID system, as recited in claim 3, wherein the narrowband communication provides power to the RFID tag.

5. The RFID system, as recited in claim 3, wherein the narrowband communication provides command signals to the RFID tag.

6. The RFID system, as recited in claim 5, wherein the RFID reader synchronizes with the RFID tag.

7. The RFID system, as recited in claim 1, wherein the RFID tag communicates with the RFID reader using pulses of approximately 60 μs in width.

8. The RFID system, as recited in claim 1, wherein the RFID tag communicates with the RFID reader using time slots of approximately 950 ps in width.

9. The RFID system, as recited in claim 1, wherein the where the RFID reader is configured to read multiple RFID tags simultaneously.

10. A radio-frequency-identification (RFID) system comprising:
an RFID tag; and
an RFID reader, where the RFID reader is configured to communicates with the RFID tag using narrowband communication initially and subsequently through broadband communication.

11. The RFID system, as recited in claim 10, wherein the broadband communication comprises ultra-wideband modulation.

12. The RFID system, as recited in claim 10, wherein the broadband communication utilizes time-hopped pulse-position modulation.

13. The RFID system, as recited in claim 12, wherein the time-hopped pulse-position modulation comprises sending from the RFID tag to the RFID reader a series of pulses in time slots selected by the RFID tag through a cryptographically secure pseudo-random generator.

14. The RFID system, as recited in claim 10, wherein the narrowband communication provides power to the RFID tag.

15. The RFID system, as recited in claim 10, wherein the narrowband communication provides command signals to the RFID tag.

16. A method of communicating within a radio-frequency-identification (RFID) system, comprising the steps of:
sending a narrowband signal from an RFID reader to an RFID tag;
receiving data signals from the RFID tag to the RFID reader through broadband communication using time-hopped pulse-position modulation and ultra-wideband modulation.

17. The method, as recited in claim 16, wherein the time-hopped pulse-position modulation comprises sending from the RFID tag to the RFID reader a series of pulses in time slots selected by the RFID tag through a cryptographically secure pseudo-random generator.

18. The method, as recited in claim 16, wherein the narrowband communication provides power to the RFID tag.

19. The method, as recited in claim 16, wherein the narrowband communication provides command signals to the RFID tag.

20. The method, as recited in claim 16, further comprising:
sending a second narrowband signal from the RFID reader to at least one additional RFID tag;
receiving data signals from the at least one additional RFID tag to the RFID reader through broadband communication using time-hopped pulse-position modulation and ultra-wideband modulation.

21. The method, as recited in claim 16, wherein the broadband communications between the RFID reader and the RFID tag and the at least one additional RFID tag are synchronized by the RFID reader.

22. The method, as recited in claim 16, wherein a brief interruption of the narrowband signal from the RFID reader acts to reset the RFID tag.

23. The method, as recited in claim 16, wherein the narrowband signal is used by the RFID tag to generate a clock signal and to synchronize the RFID system.
